(19) United States
(12) Patent Application Publication
(10) Pub. No.: US 2025/0252129 A1
(43) Pub. Date: Aug. 7, 2025

(54) COMPUTER-IMPLEMENTED METHOD AND INFORMATION PROCESSING SYSTEM

(71) Applicant: LEGALON TECHNOLOGIES, INC., Tokyo (JP)

(72) Inventors: Emiko WATANABE-INUI, Tokyo (JP); Kyugo KATSUTA, Tokyo (JP)

(73) Assignee: LEGALON TECHNOLOGIES, INC., Tokyo (JP)

(21) Appl. No.: 19/189,599

(22) Filed: Apr. 25, 2025

Related U.S. Application Data
(63) Continuation of application No. PCT/JP2023/011828, filed on Mar. 4, 2023.

(30) Foreign Application Priority Data
Oct. 26, 2022 (JP) 2022-171072

(51) Int. Cl. G06F 16/383; G06F 16/34

(52) U.S. Cl. CPC G06F 16/383; G06F 16/34

(57) ABSTRACT

A computer-implemented method comprises one or more processors configured to display a first document on a document browsing screen, retrieve, from a storage, a second document that is a document different from the first document and includes information corresponding to attribute information acquired from the first document, display the second document as a candidate for a related document related to the first document, and register the first document and the second document as related documents.

### CROSS-REFERENCE TO RELATED APPLICATION

The present application is a bypass continuation application based on and claims the benefit of priority from PCT Application No. PCT/JP2023/011828 filed Mar. 24, 2023, the entire contents of which are incorporated herein by reference.

### TECHNICAL FIELD

The present disclosure relates to a computer-implemented method and an information processing system.

### BACKGROUND

The document processing server device disclosed in Japanese Patent Laid-Open No. 2020-190905 (Patent Literature 1) retrieves document information by using, as a retrieval condition, any of a selected contract type, a retrieval keyword selected from a retrieval keyword display region, and a retrieval keyword input to a retrieval keyword input box that is designated by a user in accordance with operation content of the user, and displays a retrieval result thereof on a display unit of a terminal.

### SUMMARY

In a computer-implemented method for document processing according to an aspect of the present invention, wherein the method comprises one or more processors configured to display a first document on a document browsing screen, retrieve, from a storage, a second document that is a document different from the first document and includes information corresponding to attribute information acquired from the first document, display the second document as a candidate for a related document related to the first document, and register the first document and the second document as related documents.

### BRIEF DESCRIPTION OF DRAWINGS

FIG. 1 is a block diagram illustrating a schematic configuration of an information processing system according to a first embodiment.

FIG. 2 is a block diagram illustrating a schematic configuration of a document management server device according to the first embodiment.

FIG. 3 is a table illustrating an example of information stored in a document database according to the first embodiment.

FIG. 4A is a table illustrating an example of metadata according to the first embodiment.

FIG. 4B is a table illustrating an example of metadata according to the first embodiment.

FIG. 5 is a diagram illustrating a screen example displayed on a terminal device according to the first embodiment.

FIG. 6 is a diagram illustrating a screen example displayed on the terminal device according to the first embodiment.

FIG. 7 is a diagram illustrating a screen example displayed on the terminal device according to the first embodiment.

FIG. 8 is a diagram illustrating a screen example displayed on the terminal device according to the first embodiment.

FIG. 9 is a diagram illustrating a screen example displayed on the terminal device according to the first embodiment.

FIG. 10 is a sequence chart illustrating an operation example of the information processing system according to the first embodiment.

FIG. 11 is a sequence chart illustrating an operation example of the information processing system according to the first embodiment.

FIG. 12 is a block diagram illustrating an example of a hardware configuration of the document management server device according to the first embodiment.

FIG. 13 is a diagram illustrating an example of data included in a list file of contracts according to a second embodiment.

FIG. 14A is a diagram schematically illustrating aspects of association between contracts.

FIG. 14B is a diagram schematically illustrating aspects of association between contracts.

### DESCRIPTION OF EMBODIMENTS

The following describes embodiments of an information processing method, and an information processing system with reference to the drawings. For easiness of understanding of the description, the same constituent elements in the drawings are denoted by the same reference numeral if possible, and redundant description will not be repeated.

In general, regarding a contract, content of the contract may be amended by a memorandum and the like after the contract is once concluded. In such a case, the whole contract content cannot be grasped without checking content of a related contract such as a memorandum in addition to the content of the original contract. In a case of retrieving such a related contract by using the document processing server device disclosed in Patent Literature 1, a user may be required to perform retrieval work by himself/herself. In a case in which an appropriate keyword is not used for retrieval, there may be a possibility that a related contract is not displayed in a retrieval result although the related contract is present.

Such a problem is not limited to contracts and is also common in retrieving optional documents.

An aspect of the present invention may aim to provide a computer-implemented method and an information processing system with which presence of a related document can be grasped more easily.

### 1. FIRST EMBODIMENT

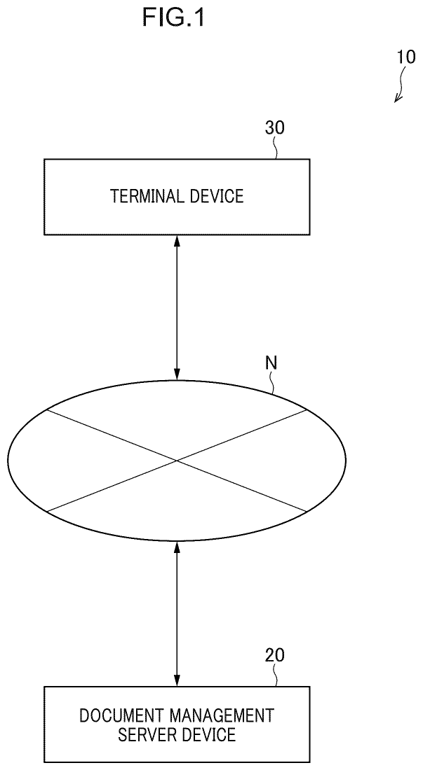

First, with reference to FIG. 1 to FIG. 11, the following describes an information processing system according to a first embodiment.

### 1.1 Schematic Configuration of Information Processing System

An information processing system 10 according to the present embodiment illustrated in FIG. 1 is a system for managing a document created by a user. In the present embodiment, the document may mean information that is recorded on the assumption that it will be referred to. The document may include, for example, an official document, a contract, a book of minutes, rules, a notification, a directory, regulations, and the like. Language of the document may be optional, and is not limited to Japanese but may be English, Chinese, or the like. A form of information of each document is not particularly limited. For example, it may be a data file created by specific word processor software and the like, or text data extracted from the data file. The following may describe a contract as an example of the “document”.

As illustrated in FIG. 1, the information processing system 10 according to the present embodiment may include a document management server device 20 and a terminal device 30. The document management server device 20 and the terminal device 30 may be connected to be able to communicate with each other via a network line N.

The document management server device 20 according to the present embodiment may be a server-type information processing device, and operate in response to a request from the terminal device 30. The document management server device 20 may include electronic components such as a Central Processing Unit (CPU, an example of a processor) having a function for processing information, a Hard Disk Drive (HDD), and a flash memory (an example of a storage unit) in a main body. The document management server device 20 may not be necessarily constituted of a single information processing device, but may be a plurality of information processing devices that operate in cooperation with each other, or may be operated by an optional cloud service. Alternatively, the function of the document management server device 20 may be implemented in the terminal device 30. In this case, a processor or a storage unit of any of a plurality of information processing devices may be used, and processing may be performed in a divided manner.

The terminal device 30 according to the present embodiment may be an information processing device such as a Personal Computer (PC) and a tablet terminal, and includes electronic components such as a CPU (an example of a processor) having a function for processing information and a flash memory (an example of a storage unit) in a main body.

The network line N may be a communication network that can implement high-speed communication, and is a wired or wireless communication network such as the Internet, an intranet, or a Local Area Network (LAN), for example.

In the information processing system 10 according to the present embodiment, account information may be assigned to each user. The account information may include an identification number and a password. The account information may be transmitted from the terminal device 30 to the document management server device 20 at the time of logging in a system of the document management server device 20, and used for authenticating the user by the document management server device 20. When the authentication is established, the user can use various services provided by the document management server device 20 by operating the terminal device 30. For example, a user can upload data of a contract created by himself/herself to the document management server device 20 to be stored therein. The document management server device 20 may also store data of a contract transmitted from an optional electronic conclusion service. The contract data stored in the document management server device 20 may be, for example, data of the contract after conclusion. Additionally, the user can browse a contract created by himself/herself in the past, or retrieve a desired contract from a plurality of contracts by operating the terminal device 30 to access a database of the document management server device 20.

### 1.2 Configuration of Document Management Server Device

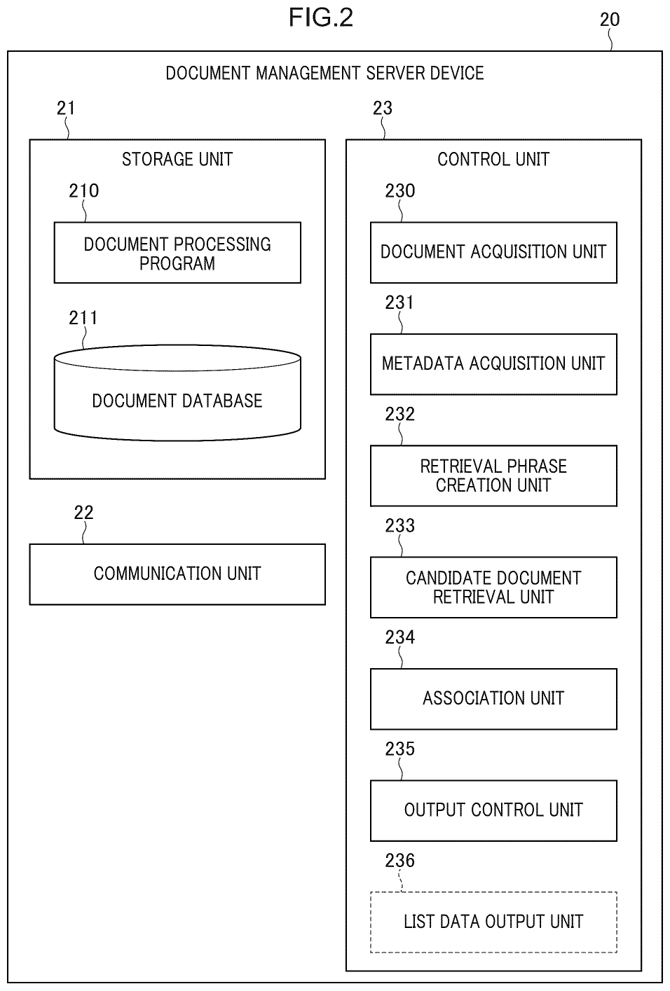

As illustrated in FIG. 2, the document management server device 20 according to the present embodiment may include a storage unit 21, a communication unit 22, and a control unit 23.

The storage unit 21 may include a non-volatile memory and the like such as an HDD and a flash memory, for example. The storage unit 21 may be electrically connected to the communication unit 22 and the control unit 23. The storage unit 21 may store a document processing program 210 and a document database 211.

The document processing program 210 according to the present embodiment may be executed by the control unit 23. The control unit 23 may function as various kinds of functional means 230 to 235 illustrated in FIG. 2, for example, by executing the document processing program 210.

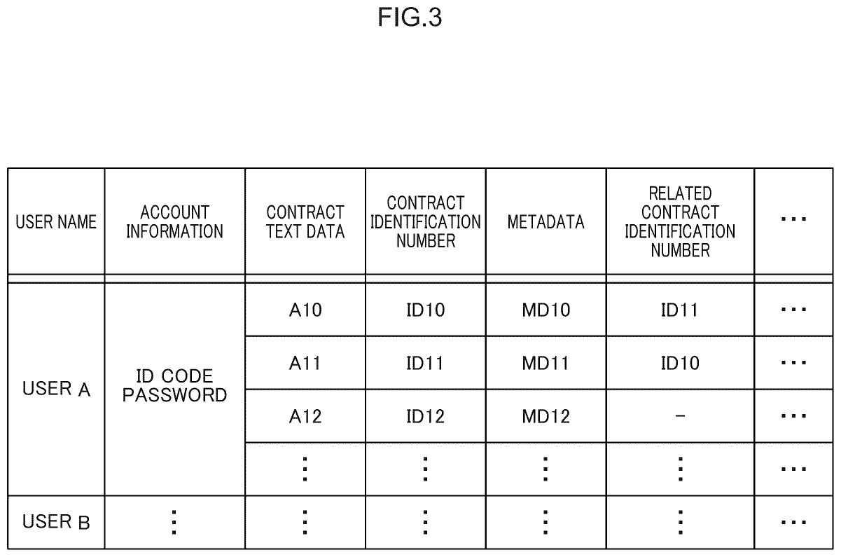

As illustrated in FIG. 3, for example, the document database 211 according to the present embodiment may store account information of the user and text data of the contract in association with each other for each user. The text data of the contract may be electronic data of the contract that is created or uploaded by the user. The electronic data of the contract may be obtained by making content of the contract text into electronic data. The electronic data of the contract text may be image information such as PDF, a text file or a Word file including text data, or the like. In the present embodiment, the contract is an example of a first document.

As illustrated in FIG. 3, for example, the document database 220 according to the present embodiment may store an identification number of the contract, metadata of the contract, an identification number of a related contract, a type of the contract, and the like in association with each other for each piece of text data of the contract. The identification number of the contract may be a number that is individually given to each contract. The metadata of the contract may be, for example, data indicating a characteristic of the contract, and include a characteristic word included in description content of the contract, data that is input separately from the content of the contract, and the like. For example, the metadata of the contract may be data such as a title of the contract, a name of a concerned party to the contract, and a contract date. The related contract may another contract related to the contract of interest. For example, in a case in which the contract of interest is a contract for business consignment, a memorandum that is concluded to amend content of the contract for business consignment may correspond to the related contract. For example, in a case in which a contract A11 corresponds to a related contract of a contract A10, as illustrated in FIG. 3, an identification number of the contract A11 may be registered to an item of an identification number of the related contract of the contract A10, and an identification number of the contract A10 may be registered to an item of an identification number of a related contract of the contract A11. In the present embodiment, the related contract is an example of a second document, and corresponds to a related document.

The communication unit 22 according to the present embodiment illustrated in FIG. 2 may function as a communication interface for communicating with the outside via the network line N illustrated in FIG. 1. The communication unit 22 may be connected to the storage unit 21 and the control unit 23. The communication unit 22 may perform various kinds of communication with the terminal device 30. For example, the communication unit 22 may receive text data of the contract transmitted from the terminal device 30. The communication unit 22 may also transmit the text data of the contract stored in the document database 220 to the terminal device 30 in response to a request from the terminal device 30.

The control unit 23 according to the present embodiment may include a processor such as a CPU. The control unit 23 may be connected to the storage unit 21 and the communication unit 22. The control unit 23 may include document acquisition unit 230, a metadata acquisition unit 231, a retrieval phrase creation unit 232, a candidate document retrieval unit 233, an association unit 234, and an output control unit 235 as functional configurations implemented by executing the document processing program 210 stored in the storage unit 21.

When the text data of the contract is uploaded from the terminal device 30, the document acquisition unit 230 according to the present embodiment may cause the text data of the contract to be stored in the document database 220. In a case in which the text data of the contract is information other than text, the document acquisition unit 230 may make the information into text by performing Optical Character Recognition (OCR) and the like.

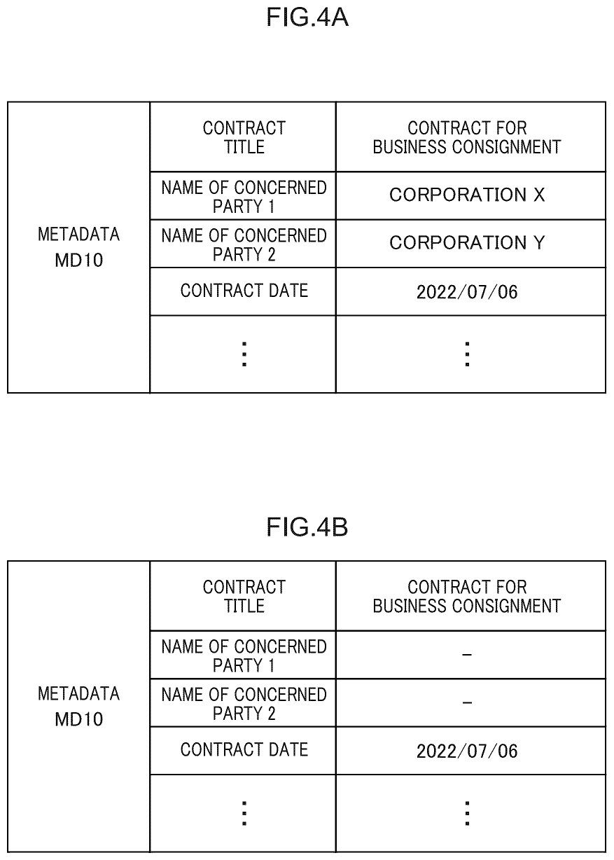

When the text data of the contract is uploaded from the terminal device 30, the metadata acquisition unit 231 according to the present embodiment may extract metadata from the text data of the contract, for example. Specifically, the metadata acquisition unit 231 may extract information of a plurality of target items set in advance such as a title of the contract, a name of a concerned party to the contract, and a contract date as illustrated in FIG. 4A, for example, as metadata from the text data of the contract by executing a first document analysis program. FIG. 4A exemplifies a case in which the metadata acquisition unit 231 may extract “contract for business consignment” as a title of the contract, extract “corporation X” and “corporation Y” as names of concerned parties, and extract “2022 Jul. 6” as a contract date. The metadata acquisition unit 231 may associate the extracted metadata with the text data of the contract to be stored in the document database 220.

In a case in which some of a plurality of extraction target items of the metadata cannot be acquired, the metadata acquisition unit 231 may cause unacquired items to be stored in the document database 220 as empty data. For example, when the metadata acquisition unit 231 may cause the text data of the contract to be stored in the document database 220, in a case in which the title of the contract and the contract date can be acquired from the text data of the contract but the names of the concerned parties to the contract cannot be extracted therefrom as illustrated in FIG. 4B, the items of the names of the concerned parties to the contract may be held as empty data.

After once extracting information of the extraction target items, the metadata acquisition unit 231 may execute a second document analysis program for further extracting the extraction target items. Due to this, the extraction target items can be acquired more accurately. For example, information of the extraction target may item of the empty data can be extracted again from the text data of the contract. For example, when the text data of the contract stored in the document database 220 is displayed on the terminal device 30, information of the name of the concerned party to the contract may be extracted again from the text data of the contract. Due to this, for example, even in a case in which the item of the name of the concerned party to the contract is empty data as illustrated in FIG. 4B, that is, in a case in which the item of empty data is present in the metadata of the contract, the metadata acquisition unit 231 can acquire information of the item more securely. The metadata acquisition unit 231 may perform processing of extracting information of the extraction target items multiple times irrespective of whether the extraction target items include empty data.

The second document analysis program may be the same program as the first document analysis program, or a program different therefrom, for example, a different algorithm with which the metadata can be extracted with higher accuracy than the first document analysis program may be used, for example. As the second document analysis program, for example, a document analysis program based on unique expression extraction can be used. In the present embodiment, the metadata of the contract acquired by the metadata acquisition unit 231 may correspond to document information acquired from the first document.

The metadata of the contract stored in the document database 220 can be manually added or changed by a manager of the document management server device 20 or the terminal device 30.

When the text data of the contract stored in the document database 220 is displayed on the terminal device 30, for example, the retrieval phrase creation unit 232 may create a retrieval phrase based on the metadata of the contract acquired by the metadata acquisition unit 231. The retrieval phrase may be a phrase and the like used when a candidate for a related contract corresponding to the contract displayed on the terminal device 30 is retrieved from the document database 220, and may correspond to what is called a retrieval query. The retrieval phrase creation unit 232 is an example of a retrieval query creation unit.

The candidate document retrieval unit 233 may retrieve, for example, a candidate for a related contract corresponding to the retrieval phrase created by the retrieval phrase creation unit 232 from the document database 220 using a predetermined search engine. The candidate document retrieval unit 233 may calculate a degree of association with the retrieval phrase as a numerical value for each of a piece or a plurality of pieces of text data of the contract stored in the document database 220, for example, and extract, as the candidate for the related contract, a piece of text data of the contract the degree of association of which is calculated to be equal to or larger than a predetermined value. In the present embodiment, the related contract or a contract extracted as a candidate for a related contract of a certain contract is an example of the second document.

In many cases, a conclusion date of a contract, a name of a contract, and the like of an original contract may be described in text, especially in a headnote, of a related contract so that the contract of the original contract can be specified. Thus, by extracting such data from the contract of the original contract as metadata and performing full text retrieval of the contract in the database based on the metadata, a candidate for the related contract can be efficiently presented.

On the other hand, the candidate document retrieval unit 233 may extract a candidate for a related contract by using metadata of each contract stored in the document database 200. For example, it is assumed that the document database 200 stores text data of each of two contracts α and β that are not associated with each other. In this case, if an own company and a counterparty described in the text data of the contract α are the same as the own company and the counterparty described in the text data of the contract β, that is, if a concerned party of the contract α is the same as a concerned party of the contract β, there may be a high possibility that the contracts α and β are related to each other. A case in which concerned parties to the contract are the same includes a case in which they are the same after aggregation of names. In a case in which such information is registered as metadata of the contract, the candidate for the related contract may be extracted and presented based thereon. The item of the metadata of the related contract may be the same as that of the contract of the original contract.

The candidate document retrieval unit 233 may not only extract a contract including all retrieval phrases as the candidate for the related contract but also may extract a contract including some of the retrieval phrases as the candidate for the related contract. For example, in a case in which the retrieval phrases include company names of three companies as names of concerned parties, the candidate document retrieval unit 233 may extract a contract including company names of at least two companies among the three companies as the candidate for the related contract. In a case in which the retrieval phrases include a title of the contract, a name of a concerned party to the contract, a contract date, and the like, the candidate document retrieval unit 233 may extract a contract including at least two of them as the candidate for the related contract. It is possible to appropriately adjust whether to extract a retrieved contract as the candidate for the related contract depending on a matching degree of the retrieved contract with such retrieval phrases.

For example, when an operation of associating the candidate for the related contract extracted by the candidate document retrieval unit 233 with the contract being browsed is performed by the terminal device 30, the association unit 234 may register the information in the document database 220. For example, it is assumed that, when data of the contract A10 is displayed on the terminal device 30 and the contract A11 is displayed as the candidate for the related contract corresponding to the contract A10, the user may perform, with the terminal device 30, an operation of associating the contract A11 with the contract A10 being browsed. In this case, the association unit 234 may add the identification number of the contract A11 to an item of a related contract in the information of the contract A10 registered in the document database 220. The association unit 234 may also add the identification number of the contract A10 to an item of a related contract in the information of the contract A11 registered in the document database 220, for example. Due to this, the contract A10 and the contract A11 may associated with each other as related contracts in the document database 220.

The output control unit 235 may display, on the terminal device 30, text data of the contract stored in the document database 220 and information such as the candidate for the related contract extracted by the candidate document retrieval unit 233, for example. Due to this, the information transmitted from the output control unit 235 may be displayed on a display unit of the terminal device 30.

Next, the following describes a screen example displayed on the display unit of the terminal device 30.

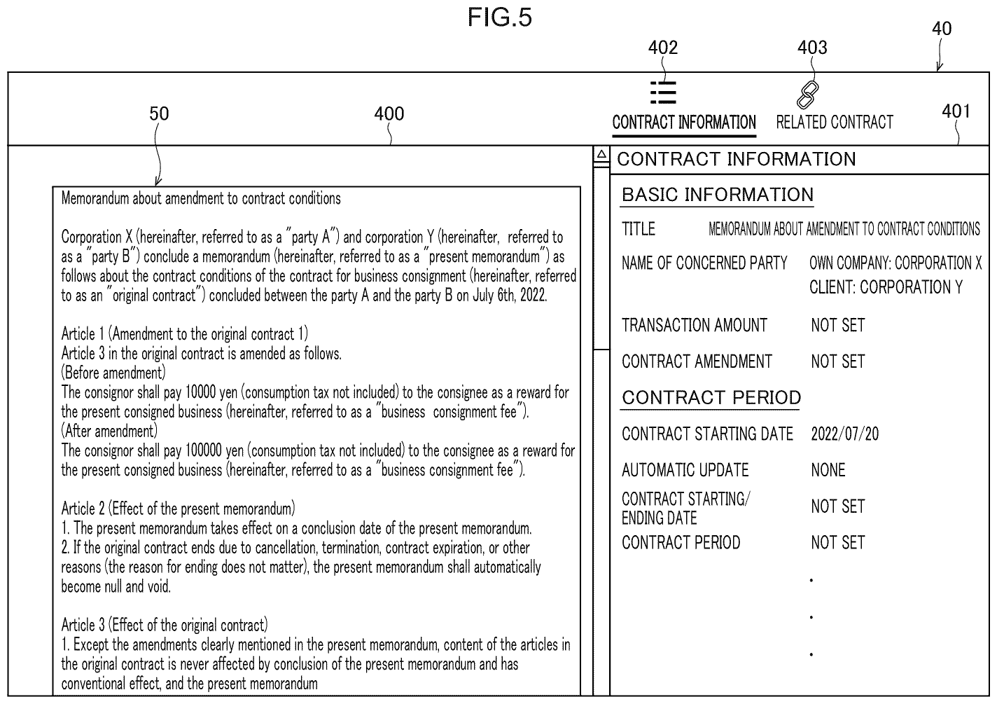

When a browsing request for a predetermined contract is transmitted from the terminal device 30 to the document management server device 20, for example, the output control unit 235 may read out text data of the contract from the document database 220 and cause the text data of the contract to be displayed on the display unit of the terminal device 30. The browsing request transmitted from the terminal device 30 may include, for example, an identification number and the like of the contract requested to be browsed. FIG. 5 illustrates an example of a document browsing screen 40 on which the text data of the contract is displayed.

As illustrated in FIG. 5, for example, a document display region 400, a related information display region 401, a first selection button 402, and a second selection button 403 may be provided on the document browsing screen 40.

For example, content of text of a contract 50 that is requested to be browsed by the user may be displayed in the document display region 400, for example. In the related information display region 401, various kinds of information related to the contract 50 being browsed may be displayed. In the present embodiment, the information displayed in the related information display region 401 can be switched by operating the first selection button 402 and the second selection button 403.

When the user operates the first selection button 402, metadata of the contract 50 being browsed may be displayed in the related information display region 401 as illustrated in FIG. 5, for example. The user can check the metadata extracted from the contract 50 being browsed by viewing the related information display region 401. In the present embodiment, the metadata is an example of various kinds of information related to the contract 50.

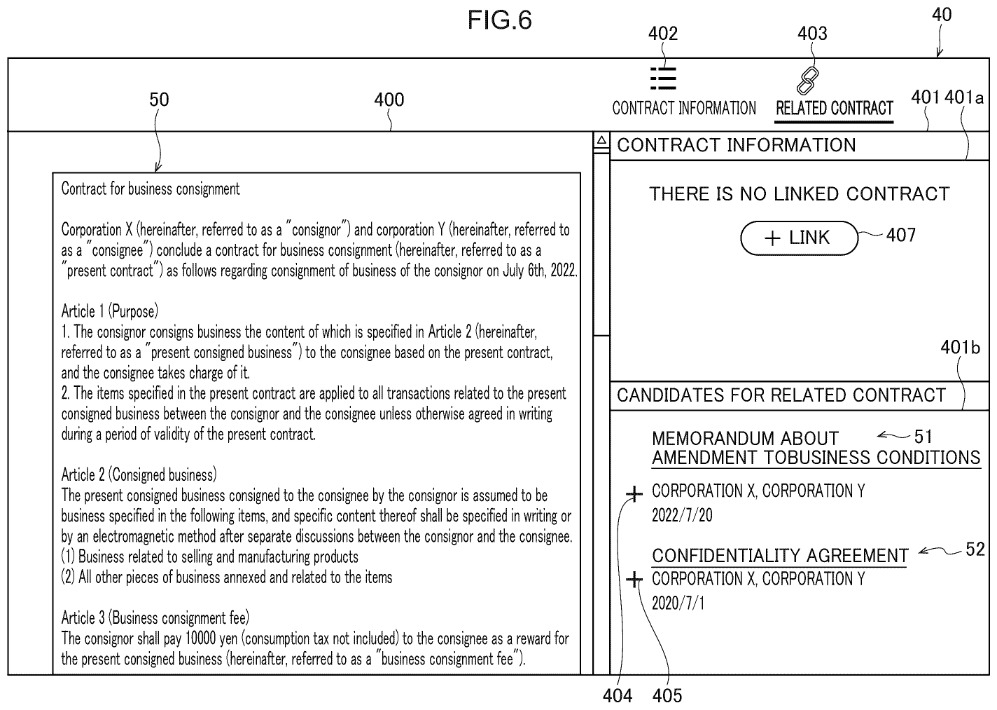

On the other hand, when the user operates the second selection button 403, a related contract display region 401a and a candidate contract display region 401b as illustrated in FIG. 6 may be displayed in the related information display region 401, for example. In the present embodiment, the candidate contract display region 401b corresponds to a first display region, and the related contract display region 401a corresponds to a second display region.

In the candidate contract display region 401b according to the present embodiment, information of the candidate for the related contract extracted by the candidate document retrieval unit 233 may be displayed. FIG. 6 exemplifies a case in which a contract 51 titled “Memorandum about amendment to business conditions” and a contract 52 titled “Confidentiality agreement” are extracted as candidates for the related contract. In displayed portions of the contracts 51 and 52, names of concerned parties and contract dates may be displayed together with the titles of the contracts. As information of the titles, the names of the concerned parties, and the contract dates of the contracts 51 and 52, information of metadata of the contracts 51 and 52 stored in the document database 220 may be used.

When a degree of association of the contract 51 calculated by the candidate document retrieval unit 233 is higher than a degree of association of the contract 52, the contract 51 may be preferably displayed with higher priority than the contract 52 in the candidate contract display region 401b as illustrated in FIG. 6. In a user interface according to the present embodiment, the contract 51 may be displayed on an upper side. Due to this, when the user views the candidate contract display region 401b, the user can recognize that the contract 51 is a contract having higher relevance to the contract 50 being browsed than the contract 52.

Display order of the contracts may also be determined by considering elements other than the degree of association. For example, by displaying the contracts in ascending order of the contract conclusion date (in order of conclusion of the contract), it is possible to assist understanding of the user about a relation among the contracts. Due to this, the related contracts can be associated with each other more appropriately.

The display order may also be determined depending on a type of the contract. For example, in joint development, contracts may be concluded in order of a confidentiality agreement, a PoC contract, a joint research and development contract, and a joint application contract in many cases. That is, there may be a case in which specific types of contracts are concluded in order that is fixed to some extent. By displaying the contracts in order corresponding to such types of the contracts, the related contracts can be associated with each other more appropriately.

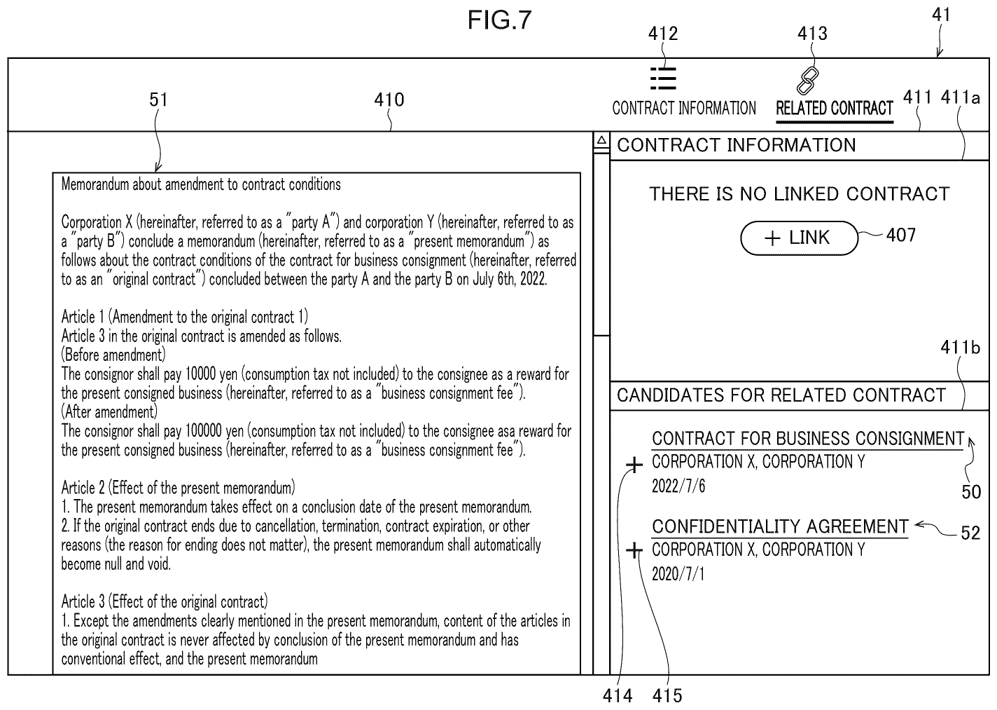

In the candidate contract display region 401b according to the present embodiment, content of the contracts 51 and 52 can be displayed by performing click operation on titles of the contracts 51 and 52. For example, when the user performs click operation on the title of the contract 51, a different document browsing screen 41 illustrated in FIG. 7 may be displayed. On the document browsing screen 41, for example, a document display region 410, a related information display region 411, a first selection button 412, and a second selection button 413 may be provided similarly to the document browsing screen 40 illustrated in FIG. 6. In the related information display region 411, for example, a related contract display region 411a and a candidate contract display region 411b may be displayed. The content of the contract 51 may be displayed in the document display region 410. In the candidate contract display region 411b, the contracts 50 and 52 may be displayed as candidates for the related contract of the contract 51.

In the candidate contract display region 411b according to the present embodiment, link buttons 414 and 415 may be displayed on a left side of portions where information of the contracts 50 and 52 is displayed. The link buttons 414 and 415 may be buttons that are operated for associating the contract 51 being browsed with the candidate for the related contract. The link button is an example of display for an operation of associating contracts.

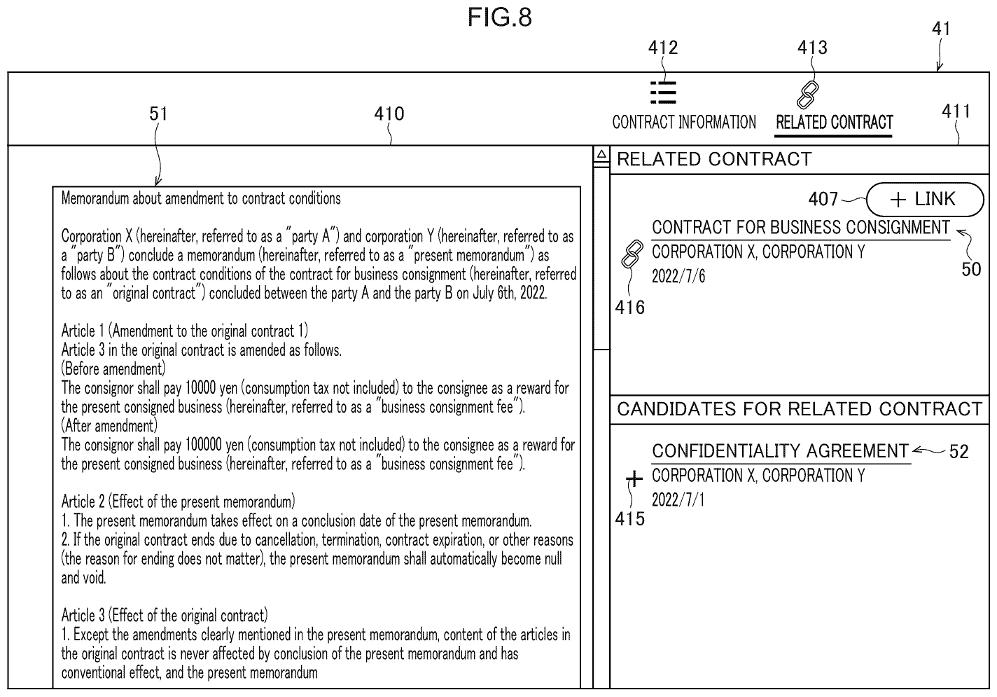

For example, it is assumed that the user determines that the contract 51 being browsed is the related contract of the contract 50 by checking the content of the contract 51 on the screen illustrated in FIG. 7, and performs click operation on the link button 414 displayed on the left side of the contract 50, the contract 51 being browsed and the contract 50 are associated with each other. In this case, as illustrated in FIG. 8, the information of the contract 50 may be displayed in the related contract display region 411a. An associating operation is not limited to clicking the link button, but may be performed by right-clicking on data of the contract to display a menu, or by dragging and dropping display of the related contract on display of the contract of the original contract to overlap therewith, for example.

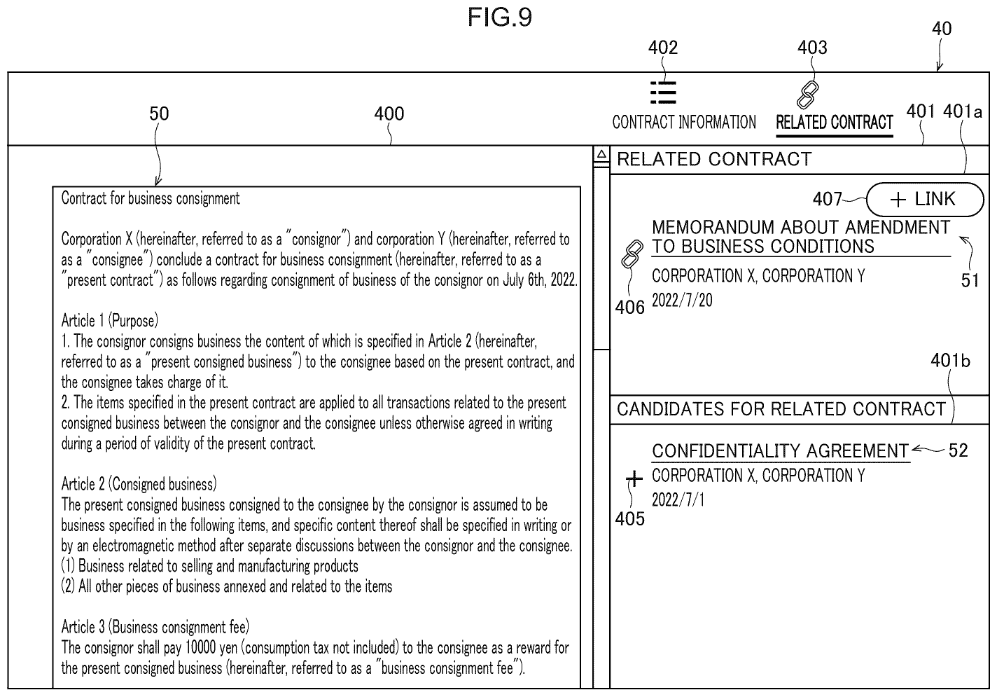

In the present embodiment, when the operation of associating the contract 50 with the contract 51 being browsed is once performed as described above, in a case in which the user displays the contract 50 thereafter, information of the contract 51 may be displayed in the related contract display region 401a. Specifically, as illustrated in FIG. 9, the information of the contract 51 may be displayed in the related contract display region 401a on the document browsing screen 40.

As illustrated in FIG. 9, when the contract 51 is associated with the contract 50 as the related contract, even if the contract 51 is extracted as the candidate for the related contract by the candidate document retrieval unit 233, it may be preferable that the output control unit 235 does not display the information of the contract 51 in the candidate contract display region 411b.

As illustrated in FIG. 8, a link release button 416 may be preferably displayed on the left side of the contract 50 in the candidate contract display region 401b. Due to this, the user can easily release association between the contract 51 being browsed and the other contract 50 by operating the link release button 416. Similarly, also on the document browsing screen 40 illustrated in FIG. 9, association between the contract 50 being browsed and the other contract 51 can be released by operating the link release button 406. The link release button is an example of display for an operation of releasing association between the contracts.

The operation of releasing association between the contracts is not limited to clicking the link release button. When an operation of associating the contracts or releasing association is performed, display for making the user to confirm whether to really perform association or release association may be provided to reduce a possibility of misoperation.

Furthermore, if there is no contract associated with the contract 50, for example, this fact may be preferably displayed in the related contract display region 401a as illustrated in FIG. 6. In this case, the user can manually associate another contract with the contract 50 by performing click operation on the link button 407 displayed in the candidate contract display region 401b. With this operation, a contract different from the contracts 51 and 52 displayed in the candidate contract display region 401b can be easily associated with the contract 50.

The link button 407 illustrated in FIG. 7 to FIG. 9 may have a function similar to that of the link button 407 illustrated in FIG. 6. The link buttons 404 and 405 illustrated in FIG. 6 and the link button 405 illustrated in FIG. 9 each may have a function similar to that of the link buttons 414 and 415 in FIG. 7.

### 1.3 Operation Example of Information Processing System

Next, the following describes an operation example of the information processing system 10 according to the present embodiment. Hereinafter, a contract browsed by the user on the terminal device 30 may be referred to as a first contract, and a contract related to the first contract is referred to as a second contract. The first contract may be, for example, a contract for business consignment, and the second contract may be, for example, a memorandum about the contract for business consignment.

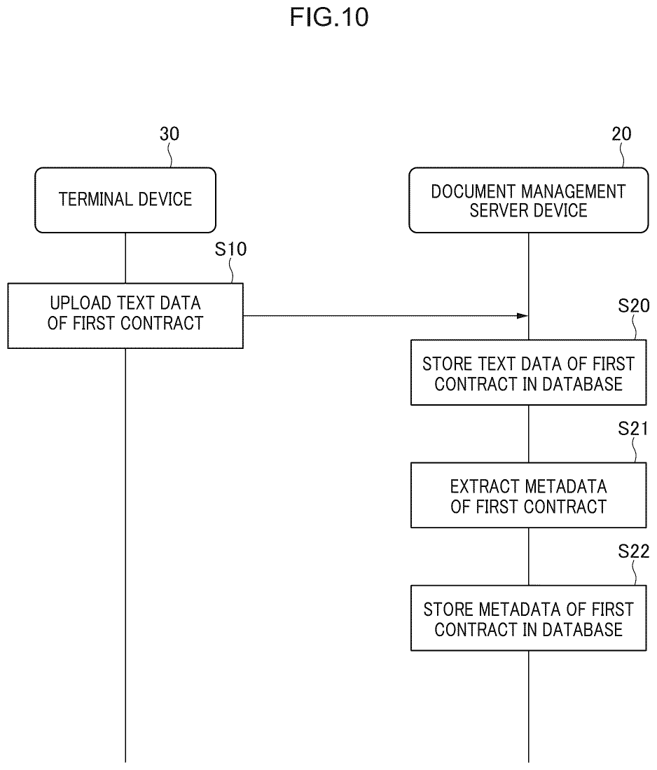

As illustrated in FIG. 10, in the information processing system 10 according to the present embodiment, when the user uploads text data of the first contract to the document management server device 20 by operating the terminal device 30 (step S10), the text data of the first contract may be stored in the document database 211 of the document management server device 20 (step S20). In the present embodiment, the first contract may correspond to a first document. At this point, in the document management server device 20, the metadata acquisition unit 231 may extract metadata from the text data of the first contract (step S21), and associate the extracted metadata with the text data of the first contract to be stored in the document database 211 (step S22).

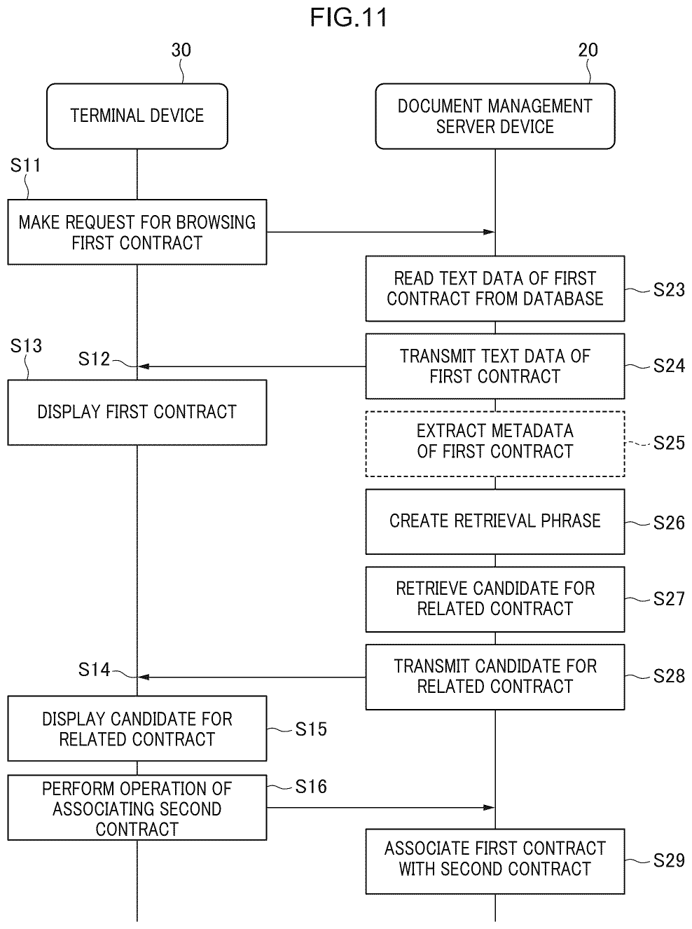

Thereafter, as illustrated in FIG. 11, when the user makes a request to the document management server device 20 for browsing the text data of the first contract by operating the terminal device 30 (step S11), the output control unit 235 of the document management server device 20 may read, from the document database 220, the text data of the first contract requested by the terminal device 30 (step S23), and transmit it to the terminal device 30 (step S24). When receiving the text data of the first contract transmitted from the document management server device 20 (step S12), the terminal device 30 may display the text data of the first contract on the display unit (step S13). Due to this, the user can browse the text data of the first contract.

While transmitting the text data of the first contract to the terminal device 30, the document management server device 20 may retrieve the related contract. Specifically, as illustrated in FIG. 11 with a dashed line, in a case in which metadata corresponding to the first contract includes empty data, the metadata acquisition unit 231 may complement the metadata by extracting metadata from the text data of the first contract (step S25). Subsequently, the retrieval phrase creation unit 232 may create a retrieval phrase based on the metadata extracted by the metadata acquisition unit 231 (step S26). The candidate document retrieval unit 233 then may retrieve a candidate for a related contract corresponding to the retrieval phrase from the document database 220 (step S27).

Thereafter, when the second selection button 403 illustrated in FIG. 5 is operated, for example, the output control unit 235 of the document management server device 20 may transmit information of the candidate for the related contract extracted by the candidate document retrieval unit 233 to the terminal device 30 (step S28). Due to this, the candidate for the contract related to the first contract being browsed may be displayed on the display unit of the terminal device 30 (step S15).

Subsequently, it is assumed that the user performs operation of associating the second contract, for example, among candidates for the related contract with the first contract being browsed on the terminal device 30 (step S16), the association unit 234 of the document management server device 20 associates the first contract being browsed with the second contract (step S29). In the present embodiment, the second contract may correspond to a second document. Thereafter, when the user browses the first contract by operating the terminal device 30, the second contract may be displayed on the terminal device 30 as the related contract. When the user browses the second contract by operating the terminal device 30, the first contract may be displayed on the terminal device 30 as the related contract.

### 1.4 Hardware Configuration of Document Management Server Device

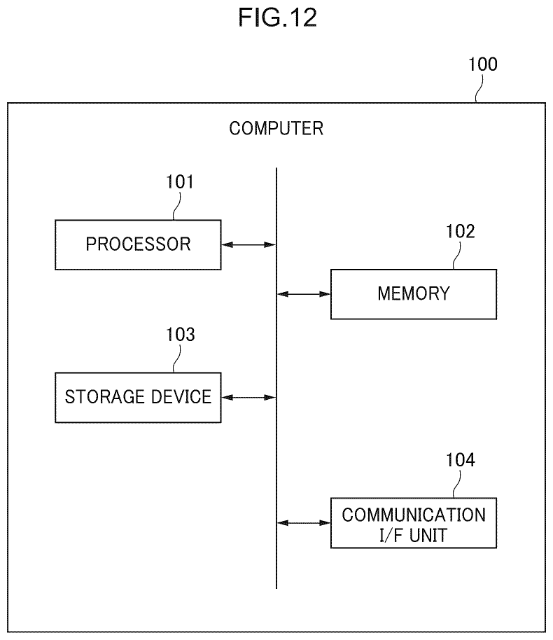

Next, the following describes an example of a hardware configuration in a case of implementing the document management server device 20 by a computer 100 with reference to FIG. 12.

As illustrated in FIG. 12, the computer 100 may include, for example, a processor 101, a memory 102, a storage device 103, and a communication interface (I/F) unit 104.

The computer 100 may be, for example, a cloud computer, a server computer, a personal computer (for example, a desktop, a laptop, a tablet, and the like), a media computer platform (for example, a cable, a satellite set-top box, a digital video recorder, and the like), a hand-held computer device (for example, a PDA, an electronic mail client, and the like), another type of computer, or a communication platform.

The processor 101 may be a control unit that controls various kinds of processing in the computer 100 by executing a program stored in the memory 102.

The memory 102 may be, for example, a storage medium such as a Random Access Memory (RAM). The memory 102 temporarily may store a code of a program executed by the processor 101, and data required to execute the program.

The storage device 103 may be, for example, a non-volatile storage medium such as a hard disk drive (HDD) and a flash memory, for example. The storage device 103 may store an operating system and various kinds of programs for implementing the configurations described above.

The communication interface unit 104 may be a device for performing data communication with a device external to the computer 100 via a network such as the Internet in a wired or wireless manner. The communication interface unit 104 may be provided outside the computer 100. In a case in which the communication interface unit 104 is provided outside the computer 100, the communication interface unit 104 may be connected to the computer 100 via an interface such as USB, for example.

### 1.5 Working and Effect of Information Processing System According to First Embodiment

As described above, in the information processing system 10 according to the present embodiment, the control unit 23 of the document management server device 20 may display the first contract stored in the document database 211 on the document browsing screen 40 based on an operation by the user, retrieve, from the document database 211, the second contract including the information corresponding to the metadata acquired from the first contract, and display the second contract as the candidate for the related contract related to the first contract on the document browsing screen 40.

With this configuration, when the user browses the first contract on the document browsing screen 40, the second contract may be displayed as the candidate for the related contract corresponding to the first contract on the document browsing screen 40. Thus, the user can notice presence of the related contract without performing retrieval work and the like by himself/herself. Accordingly, the user can grasp presence of the related contract more easily.

The control unit 23 of the document management server device 20 may acquire, as metadata, attribute information corresponding to each of the target items set in advance from the first contract. The attribute information may be acquired as character information, for example. The target items may include at least one of a title of the first contract, a concerned party to the first contract, and a contract date of the first contract.

With this configuration, the second contract may be retrieved based on at least one of the title of the first contract, the concerned party to the first contract, and the contract date of the first contract, so that the second contract related to the first contract may be easily retrieved.

At the time of retrieving the second contract related to the first contract from the document database 211, the control unit 23 of the document management server device 20 may calculate a degree of association between description content of the second contract and the metadata of the first contract. In a case of displaying a plurality of second contracts on the document browsing screen 40 as candidates for the related contract, the control unit 23 may display the second contracts in descending order of the degree of association in the related contract display region 401a.

With this configuration, the user can easily recognize that, among the second contracts displayed in the related contract display region 401a, the second contract displayed first is a contract most related to the first contract. Accordingly, convenience for the user can be improved.

The control unit 23 of the document management server device 20 may acquire the metadata from the first contract when causing the first contract to be stored in the document database 211. The control unit 23 may also acquire the metadata from the first contract when causing the first contract to be displayed on the document browsing screen 40.

With this configuration, the metadata can be easily acquired from the first contract.

When the user performs an operation of associating the first contract being browsed with the second contract as the candidate for the related contract on the document browsing screen 40, the control unit 23 of the document management server device 20 may associate the first contract with the second contract.

With this configuration, the first contract and the second contract can be easily associated with each other, so that convenience for the user can be improved.

As illustrated in FIG. 9, on the document browsing screen 40, the candidate contract display region 401b in which the contract 52 as the candidate for the related contract is displayed and the related contract display region 401a in which the contract 51 associated with the first contract is displayed may be provided. In the example illustrated in FIG. 9, the contract 52 may correspond to the second document, and the contract 51 may correspond to a third document.

With this configuration, the user can easily check the contract 52 as the candidate for the contract related to the contract 50 being browsed and the contract 51 actually associated with the contract 50, so that convenience for the user can be improved.

### 2. SECOND EMBODIMENT

Next, the following describes the information processing system 10 according to a second embodiment. Hereinafter, differences from the information processing system 10 according to the first embodiment will be mainly described.

### 2.1 Configuration of Information Management Server Device

As illustrated in FIG. 2 with a dashed line, the control unit 23 according to the present embodiment further may include a list data output unit 236 as a functional configuration that is implemented by executing the document processing program 210 stored in the storage unit 21.

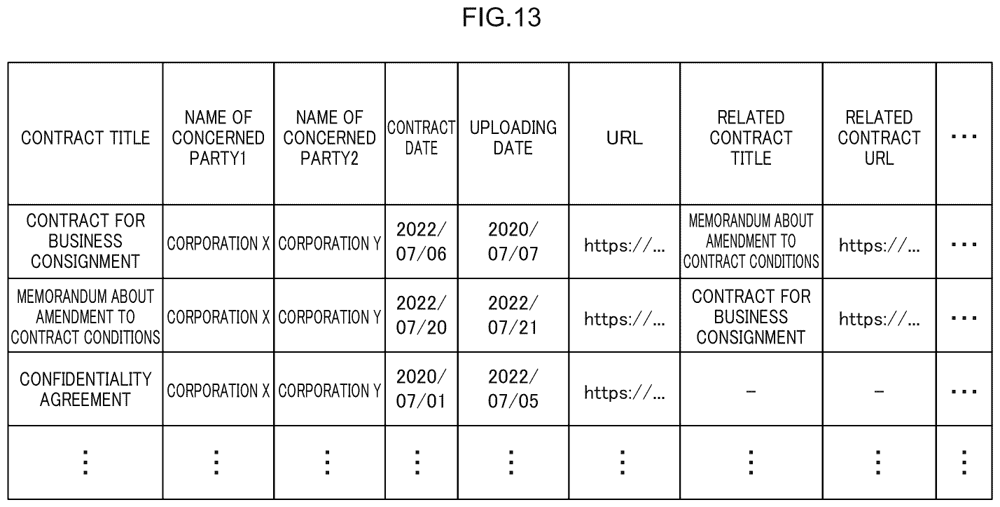

The list data output unit 236 may extract information of all contracts corresponding to the identification number of the user of the terminal device 30 from the document database 220 in response to a request from the terminal device 30, display a list display screen with which the extracted contracts can be checked as a list on the terminal device 30, and create a list file with which the extracted contracts can be displayed as a list. In the list file of the contracts, as illustrated in FIG. 13, a title of a contract, a name of a concerned party, a contract date, an uploading date, and a Uniform Resource Locator (URL) that enables access to a target contract by using Web software and the like may be described for each contract. Additionally, in the list file of the contracts, a title of a related contract associated by the association unit 234, and a URL that enables access to the related contract by using Web software and the like may be described for each contract. The list data output unit 236 may transmit the created list file to the terminal device 30. The user can download the list file to a terminal of the user, and can process it by using spreadsheet software and the like.

### 2.2 Working and Effect of Information Processing System According to Second Embodiment

The control unit 23 of the document management server device 20 may extract information of a single or a plurality of contracts of the user stored in the document database 220, display a list display screen with which the extracted information of the single or plurality of contracts as a list, and create a list file including information of other contracts associated with the former contracts that can be downloaded by the user.

With this configuration, by displaying the list file by predetermined software, the user can easily check all of the contracts managed by the document management server device 20. Furthermore, information of other contracts associated with a predetermined contract may be displayed in the list of contracts, so that the user can easily grasp presence of a related contract.

### 3. OTHER EMBODIMENTS

The present disclosure is not limited to the specific examples described above.

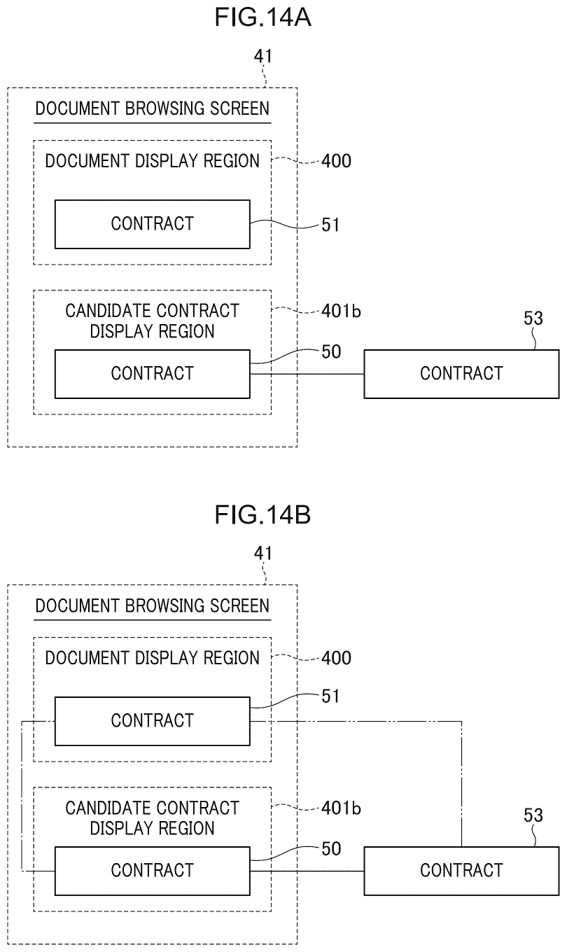

For example, there may be a case in which, when the contract 50 is displayed as a candidate for the related contract in the candidate contract display region 411b of the document browsing screen 41 as illustrated in FIG. 7, another contract 53 has been already associated with the contract 50. FIG. 14A schematically illustrates a relation between the first contract 50 and the second contract 51 illustrated in FIG. 7, and a relation between the first contract 50 and the third contract 53. In FIG. 14A, a solid line connecting the first contract 50 to the third contract 53 may indicate that they are associated with each other. In such a case, when the user moves a mouse pointer to a portion of the title of the contract 50 in the candidate contract display region 411b illustrated in FIG. 7, for example, the fact that the other contract 53 has been already associated with the contract 50 may be displayed on the document browsing screen 41 by pop-up and the like. With this configuration, the user can easily recognize that the other contract 53 has been already associated with the contract 50. In a case of displaying association between the contracts, it may be preferably displayed as a graph so that a relation among a plurality of contracts can be visually understood.

On the document browsing screen 41 illustrated in FIG. 7, when the user moves a mouse pointer to a portion of the title of the contract 50 in the candidate contract display region 411b, the text of the contract 50 may be displayed by pop-up and the like. Due to this, the user can easily compare the text of the contract 51 displayed in the document display region 410 of the document browsing screen 41 with the text of the contract 50, so that whether the contract 50 and the contract 51 may be associated with each other can be easily determined.

When the other contract 53 has been already associated with the contract 50 as illustrated in FIG. 14A, the association unit 234 may perform processing of automatically associating the contract 53 with the contract 51 as indicated by a two-dot chain line in FIG. 14B when the user performs an operation of associating the contract 50 with the contract 51 being browsed as indicated by an alternate long and short dash line in FIG. 14B. With this configuration, a series of related contracts can be associated with each other as a whole by single operation, so that convenience for the user can be further improved.

The embodiments described above intend to facilitate understanding of the present invention, and does not intend to interpret the present invention in a limited manner. The present invention can be modified/improved without departing from the gist thereof, and the present invention encompasses equivalents thereof.

The processing and procedures according to the present disclosure may be implemented by not only the devices clearly described in the embodiments but also software, hardware, or a combination thereof. Specifically, the processing and procedures described in the present specification may be implemented by implementing logic corresponding to the processing on a medium such as an integrated circuit, a volatile memory, a non-volatile memory, a magnetic disc, and an optical storage. The processing and procedures described in the present specification may be executed by various kinds of computers including a terminal device and a server device in which the processing and procedures are implemented as computer programs.

In the embodiment described above, a configuration of managing various kinds of data for each user in the document database 211 as illustrated in FIG. 3 is exemplified, but a data management method in the document database 211 is not limited thereto. For example, various kinds of data may be managed for each organization to which a plurality of users belong in the document database 211. In this case, if a plurality of pieces of data of contracts associated with a predetermined organization are present, it is effective to selectively set whether to give or not to give access authority for the data of the contracts to a plurality of users belonging to the predetermined organization. Due to this, it is possible to prevent an unintended user from browsing the data of the contracts. It is assumed that, in a situation where a certain user has access authority for a contract B10 but does not have access authority for a contract B11, the contract B10 and the contract B11 are associated with each other. In this case, when the user browses text data of the contract B10 on the document browsing screen, character information of “There is a related contract for which you don't have browsing authority” may be displayed on the document browsing screen. Furthermore, in such a case, the contract B11 may be caused not to be displayed as the candidate for the related contract in the candidate contract display region on the document browsing screen.

As a method of extracting the candidate for the related contract, the candidate document retrieval unit 233 can use an optional extraction method, not limited to the extraction method using a retrieval phrase. For example, the control unit 23 of the document management server device 20 may include a retrieval query creation unit that constructs a vector (sequence) from the metadata of the contract. In this case, the candidate document retrieval unit 233 retrieves the candidate for the related contract from the document database 220 based on the vector constructed by the retrieval query creation unit. In this case, the vector corresponds to a retrieval query. In this way, the candidate document retrieval unit 233 can extract the candidate for the related contract by using an optional method of comparing characteristics of documents.

The processing and procedures described to be executed by a single device, a single piece of software, a single component, and/or a single module in the present specification may be executed by a plurality of devices, a plurality of pieces of software, a plurality of components, and/or a plurality of modules. The various kinds of information described to be stored in a single memory or storage device in the present specification may be distributed and stored in a plurality of memories included in a single device or a plurality of memories that are distributed across a plurality of devices.

Furthermore, a plurality of pieces of software and hardware described in the present specification may be implemented by integrating them into a smaller number of constituent elements or disassembling them into a larger number of constituent elements.

### 4. NOTES

The disclosed embodiment further discloses the following a note.

### Note 1

An information processing program, causing a processor to execute displaying a first document stored in a storage unit on a document browsing screen, retrieving, from the storage unit, a second document that is a document different from the first document and includes information corresponding to attribute information acquired from the first document, displaying the second document as a candidate for a related document related to the first document on the document browsing screen, and registering the first document and the second document as related documents based on an operation by a user.

What is claimed is:

1. A computer-implemented method for document processing, wherein the method comprises:
one or more processors configured to:
display a first document on a document browsing screen,
retrieve, from a storage, a second document that is a document different from the first document and includes information corresponding to attribute information acquired from the first document,
display the second document as a candidate for a related document related to the first document, and
register the first document and the second document as related documents.

2. The computer-implemented method according to claim 1, wherein the attribute information corresponds to each of a plurality of target items set in advance based on the first document.

3. The computer-implemented method according to claim 2, wherein the target items include at least one of a title of the first document, a name of a concerned party to the first document, and a contract date of the first document.

4. The computer-implemented method according to claim 1, wherein, in a case of displaying a plurality of the second documents on the document browsing screen as candidates for the related document, the second documents are displayed in descending order of a degree of association that is calculated based on description content of the second document and the attribute information at a time of retrieving the second document from the storage.

5. The computer-implemented method according to claim 2, wherein one or more processors are configured to acquire the attribute information corresponding to the target item from data of the first document at a time of storing the data of the first document in the storage.

6. The computer-implemented method according to claim 2, wherein one or more processors are configured to acquire the attribute information corresponding to the target item from the first document at a time of displaying the first document on the document browsing screen.

7. The computer-implemented method according to claim 1, wherein a first display region in which the second document as a candidate for the related document is displayed and a second display region in which a third document associated with the first document is displayed are separately provided on the document browsing screen.

8. The computer-implemented method according to claim 1, one or more processors are configured to:
display a list display screen on which extracted information of a single or a plurality of the documents stored in the storage is checked as a list; and
create a list file including information of another document associated with the documents, the list file being able to be downloaded by a user.

9. An information processing system comprising:
a storage storing a computer-readable program; and
one or more processor configured to execute the program, wherein
by executing the program, one or more processors:
display a first document on a document browsing screen,
retrieve, from the storage, a second document that includes information corresponding to attribute information acquired from the first document,
display the second document as a candidate for a related document related to the first document, and
register the first document and the second document as related documents.
